(19) United States
(12) Patent Application Publication
(10) Pub. No.: US 2024/0200329 A1
(43) Pub. Date: Jun. 20, 2024

(54) MOUNTING CLAMP FOR SUPPORT ASSEMBLY

(71) Applicant: ASC Engineered Solutions, LLC, Portsmouth, NH (US)

(72) Inventors: Joseph William Beagen, JR., North Attleboro, MA (US); Gregory Steven Doucette, Wood River Junction, RI (US); Gregory Nicholas Stagliano Ohnemus, Providence, RI (US); John Walton, Falmouth, ME (US); Mindy Phung, Houston, TX (US); Andrew Edge, Grand Rapids, MI (US); Yuen S. Chan, Greenwich, RI (US)

(21) Appl. No.: 18/068,555

(22) Filed: Dec. 20, 2022

(51) Int. Cl. E04B 9/16; E04B 9/06; E04B 9/34

(52) U.S. Cl. CPC E04B 9/16; E04B 9/064; E04B 9/345; A62C 35/68

(57) ABSTRACT

A support assembly supports a hub coupled to a crossbar. The hub adjustably supports a sprinkler, e.g., in a ceiling. Clamp assemblies are arranged and clamped on opposite sides of the crossbar to couple the support assembly to span two parallel T-bars of the ceiling. The clamp assembly comprises a carriage, a clamp, and a saddle. The carriage defines a tab comprising a first aperture and a back panel defining a second aperture adapted to support the crossbar, the hub, and the sprinkler. A lateral section of the carriage extends between the tab and the back panel. The lateral section comprises a pivoting slot and a bent end. The clamp comprises projections, a void, and a bent clasp. The saddle comprises a stem interposed between first and second flanges with orifices adapted to support the crossbar and align with the apertures in the carriage.

### TECHNICAL FIELD

This disclosure relates to support structures for systems within a building. More specifically, this disclosure relates to mounting brackets for support structures.

### BACKGROUND

Ceiling frame mounting assemblies are used to support connections to a ceiling frame, such as in commercial buildings. Lights, sprinklers, vents, wiring, and other electrical, mechanical, HVAC, or other systems may be connected to a ceiling frame. A mounting assembly can connect the system to the ceiling frame. Such systems can become damaged or fail in high vibratory and/or heat conditions during a natural disaster, such as a fire, earthquake, or hurricane.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

In one aspect, a clamp assembly comprises a carriage, a clamp, and a saddle. The carriage comprises a tab with a first aperture and a back panel with a second aperture. The first and second apertures can be adapted to support a crossbar. A lateral section extends between the tab and the back panel. The lateral section of the carriage comprises a pivoting slot and a bent end. The clamp comprises a pair of projections, a void, and a bent clasp. The saddle comprises a first flange and a second flange. The first flange comprises a first orifice adapted to support the crossbar and align with the first aperture. The second flange comprises a second orifice that supports the crossbar and aligns with the second aperture. A stem of the saddle is interposed between the first flange and the second flange.

In a further aspect, a saddle for a fire sprinkler assembly is disclosed. The saddle comprises a pair of flanges. Each flange portion comprises an opening adapted to receive a crossbar. The flange portion is configured to partially surround components of a carriage supporting the crossbar, such that a depth measured between the inner surfaces of the flanges is greater than a depth of the carriage. A stem portion of the saddle is interposed between the flanges. The stem portion comprises a fastener hole. When a fastener is tightened in the fastener hole, the flanges apply a load in double-shear, and the carriage reacts the applied load in double-shear. A length of a moment arm of the stem portion is proportional to the depth of the saddle and is greater than a length of a moment arm of the carriage proportional to the depth of the carriage.

In yet another aspect, a support assembly is disclosed. The support assembly comprises a hub with a pair of clamp assemblies. The hub is slidably coupled to a crossbar to support a sprinkler. The clamp assemblies support the hub on opposite sides of the crossbar. Each clamp assembly couples to a T-bar in the ceiling frame. Each clamp assembly comprises a carriage, a clamp, and a saddle. The carriage comprises a tab and a back panel, each defining an aperture adapted to support the crossbar. A lateral section extends between the tab and the back panel and comprises a pivoting slot and a bent end. Each clamp comprises a pair of projections, a void, and a bent clasp. Each saddle comprises a stem interposed between a first flange and a second flange, each comprising an orifice adapted to support the crossbar and align with the apertures of the carriage.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be comprised within the present disclosure and protected by the accompanying claims. The features and advantages of such implementations may be realized and obtained by means of the systems, methods, and features particularly pointed out in the appended claims. These and other features will become more fully apparent from the following description and appended claims or may be learned by the practice of such exemplary implementations.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for consistency and clarity.

FIG. 1 is an elevated perspective view of a support assembly in accordance with one aspect of the current disclosure.

FIG. 2 is an exploded view of a clamp assembly of FIG. 1.

FIG. 3 is an elevated perspective view of the clamp assembly of FIG. 2 coupled to a crossbar.

FIG. 4 is an elevated perspective view of the clamp assembly of FIG. 3 with a clamp of the clamp assembly shown in an open position.

FIG. 5 is an elevated perspective view of the clamp assembly of FIG. 3, with the clamp shown in a closed-unlocked position.

FIG. 6 is an elevated perspective view of the clamp assembly c with the clamp shown in a closed and locked position.

FIG. 7 is a left-side orthogonal view of the clamp assembly of FIG. 3 in an unlocked, open, or unclamped position.

FIG. 8 is a left-side orthogonal view of the clamp assembly of FIG. 3 in a locked, closed, and clamped position.

FIG. 9 is a right-side orthogonal view of the clamp assembly of FIG. 3 in an unlocked, open, or unclamped position.

FIG. 10 is a right-side orthogonal view of the clamp assembly of FIG. 3 in a locked, closed, and clamped position.

FIG. 11 is a front-side orthogonal view of a carriage of the clamp assembly of FIG. 3 without the clamp.

FIG. 12 is a front-side orthogonal view of the clamp assembly of FIG. 3 with the carriage and the clamp of FIG. 4 in a locked position.

FIG. 13 is an isolated side perspective view of the carriage of FIG. 11.

FIG. 14 is an isolated side perspective view of the clamp of FIG. 4.

### DETAILED DESCRIPTION

The present disclosure can be understood more readily by reference to the following detailed description, examples, drawings, and claims, and their previous and following description. However, before the present devices, systems, and/or methods are disclosed and described, it is understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

Support assemblies for various systems integrations provide a customizable structure to support various system components. The support assembly for an integrated system can provide structural support during high vibrational loads. In particular, it is desirable to find a clamp system to quickly and securely support systems in the ceiling assembly, such as fire sprinklers, lights, vents, fire alarms, water, electric, structural, and/or other systems. The support system enables an operator to make a firm connection without additional tooling or testing. In one aspect, a clamp assembly can create a stable support assembly for a sprinkler assembly. The associated methods, systems, devices, and various apparatuses of the sprinkler and clamp assemblies are disclosed herein. The clamp assembly can provide a carriage that can be free to slide along a crossbar, permitting an operator to adjust a width of the crossbar supported between ceiling frames. A clamp of the clamp assembly can be rotated about a pivot point about the ceiling frame and locked in a locking position. This can enable an operator to quickly install a stable support assembly, e.g., for fire sprinklers, without using tools. Moreover, using the same clamp and ceiling frame on both sides of the crossbar can facilitate manufacture and reduce the cost of the clamp assembly since the parts can be stamped and bent from sheet metal.

In one aspect, support assembly 100 can comprise a mounting clamp illustrated as clamp assembly 102 comprising a rotatable clamp 104 installed within a carriage 106 and rotated to lock clamp assembly 102. A saddle 108 can be added over a crossbar 110 extending between two opposed ceiling frames shown as T-bars 112 (e.g., traves, hat-channels, frames, etc.) to improve the structural integrity of a joint between clamp assembly 102 and crossbar 110. As used herein, ceiling frames (shown as T-bars 112) can have different sizes, shapes, and/or distances. For example, the axial length of the T-bars 112 and/or lateral distances between the T-bars 112 can vary between different ceiling frames and/or installations.

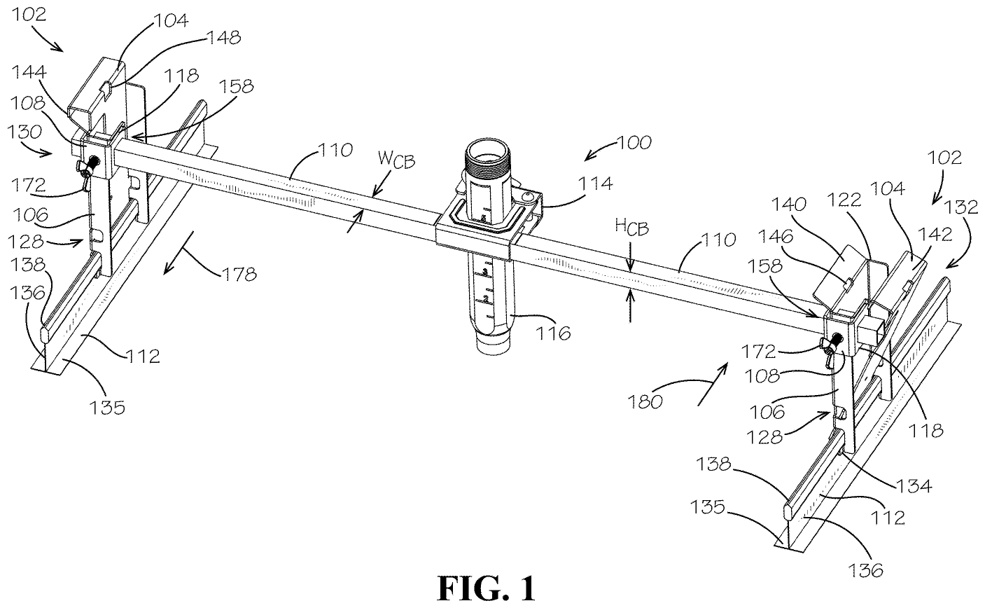

FIG. 1 shows a support assembly 100 comprising a hub 114 slidably coupled to crossbar 110. Hub 114 adjusts to support a sprinkler 116 at various locations in between ceiling frames, shown as T-bars 112. Hub 114 and/or sprinkler 116 can be similar to the hub and/or sprinkler, for example, and without limitation, in U.S. Pat. Nos. 9,889,327 and 10,527,203, which are incorporated herein by reference in their entireties. Clamp assemblies 102 can be paired on opposite sides of crossbar 110. Each clamp assembly 102 comprises a cooperating clamp 104 and carriage 106 that capture a portion of T-bar 112 to securely couple clamp assembly 102 to T-bar 112.

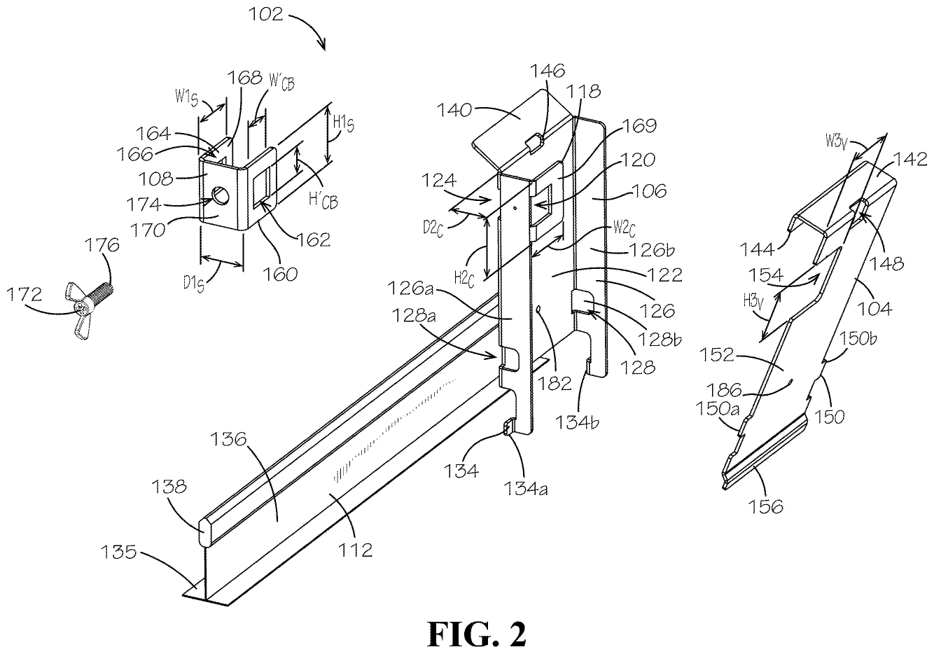

FIG. 2 is an exploded view of a clamp assembly 102 of FIG. 1. As shown in FIG. 2, each clamp assembly 102 can comprise clamp 104, carriage 106, and saddle 108, arranged around a T-bar 112 to capture a portion of T-bar 112 and support sprinkler 116 (FIG. 1) at hub 114 (FIG. 1). Each clamp assembly 102 can be formed from a stamped sheet metal bent into a three-dimensional shape. For example, clamp 104, carriage 106, and/or saddle 108 of the clamp assembly 102 can be fabricated by stamping or cutting a piece of sheet metal to form the metal into a blank (e.g., an unbent, cut flat piece of sheet metal). The blank can then be bent to form the three-dimensional structures of clamp 104, carriage 106, and/or saddle 108, as shown in FIGS. 1 and 2. Clamp 104, carriage 106, and/or saddle 108 can be stamped and bent sheet metal to form their three-dimensional structure.

Concerning FIGS. 1 and 2, each clamp assembly 102 in the support assembly 100 can be identical or the same. Each component of clamp assembly 102 can be the same as its opposing clamp assembly component coupled on an opposite T-bar 112. Coupling a pair, or more, of clamp assemblies 102 provides two opposing attachments to the T-bar 112 of the ceiling frame to securely support crossbar 110. This configuration supports a support assembly 100 during expected vibratory, heat, and miscellaneous loads that a sprinkler 116 can be exposed to during a fire or other emergency.

Using the same components facilitates the manufacture, repair, replacement, and/or installation of the clamp assembly 102, for example, by reducing the number of parts that need to be manufactured and provides consistency when a plurality of fire sprinkler support assemblies 100 are installed across a variety of T-bars 112. In various aspects, two opposed clamp assemblies 102 can be the same size and/or shape, for example, when locked. When the clamp assemblies 102 are oriented in the same orientation relative to crossbar 110, clamp 104, carriage 106, and/or saddle 108 of the pair of clamp assemblies 102 can each be clamped to opposing T-bars 112 to support the crossbar 110 and hub 114 supporting the sprinkler 116.

Clamp assembly 102 comprises a carriage 106 with a bent structure with a cutout, shown as tab 118 defining a first aperture 120. Carriage 106 comprises a back panel 122 opposite tab 118 that defines a second aperture 124 adapted to support crossbar 110. A lateral section 126 extends between tab 118 and the back panel 122. Lateral section 126 comprises a pivoting slot 128 and a bent end 134 in a lower portion of lateral section 126. Pivoting slot 128 is an opening (or void) that facilitates insertion and rotation of the clamp 104 within carriage 106 to complete and lock clamp assembly 102 in a locked position 130 on T-bar 112. (Left-side of FIG. 1 shows clamp 104 in the locked position 130, and the right side of FIG. 1 shows the unlocked position 132; also, FIG. 4 shows clamp assembly 102 in the unlocked position 132, and FIG. 6 shows the locked position 130).

Carriage 106 can comprise a pair of opposing lateral sections 126 (e.g., lateral section 126a and lateral section 126b, shown in FIG. 2), each comprising a pivoting slot 128 (e.g., pivot slot 128a and pivot slot 128b) such that the pivoting slot 128 supports both sides of the clamp 104 within carriage 106. The bent ends 134 (e.g., bent end 134a and bent end 134b) can be approximately parallel to a side or web 136 of T-bar 112. T-bar 112 can comprise a bottom flange 135 that extends approximately perpendicular to web 136 and supports the T-bar 112, e.g., in bending. T-bar 112 can comprise a toe 138 on the top side of web 136 above bent end 134 of carriage 106. Toe 138 can further secure clamp assembly 102 to T-bar 112. Bent ends 134 facilitate and support coupling carriage 106 on web 136 by increasing the normal force exerted by carriage 106 on T-bar 112 without puncturing web 136. In other words, each bent end 134 helps distribute the clamping force on web 136 of T-bar 112 to support clamp assembly 102 in the locked position 130.

In various aspects, pivoting slots 128 can be located nearer the bottom end of back panel 122, such that they are below a midline height of back panel 122 defined halfway between the top and bottom of back panel 122. For example, the midline can be defined at a midline of back panel 122 and/or the midline of the first lateral section 126a and/or the second lateral section 126b.

Carriage 106 can also comprise an elevated ridge 140 that cooperates with and couples to an elevated section 142 of clamp 104. Elevated ridge 140 can extend at an acute angle from back panel 122 of carriage 106 to interact and/or be captured by clamp 104. Clamp 104 can have an elevated section 142 of clamp 104 that can rotate over and capture elevated ridge 140 to secure clamp 104 against carriage 106 and lock clamp assembly 102 in the locked position 130. For example, the elevated section 142 can comprise a lip 144 that captures elevated ridge 140 (e.g., an edge or wall) such that a biasing force in the elevated section 142 can prevent inadvertent jostling or vibrations from releasing clamp 104 from carriage 106 and securing clamp assembly 102 remains in the locked position 130.

Elevated ridge 140 of carriage 106 can also comprise a tool mount 146 configured to receive an end of a tool 125, such as the end of a flathead or other screwdriver. Elevated section 142 of clamp 104 further comprises a through-hole 148 extending through body 152 and can extend through lip 144 and/or back panel 122 to permit an operator to insert or extend tool 125, such as a screwdriver, into through-hole 148 of clamp 104 when the clamp 104 is closed in locked position 130. The screwdriver can extend and rest on tool mount 146 of carriage 106. In this orientation, an operator can pry the screwdriver against lip 144 to release elevated section 142 of clamp 104 from elevated ridge 140 of carriage 106. In this way, an operator can move clamp 104 from the locked position 130 to the unlocked position 132 with a simple hand-held tool 125. When tool 125 is rotated against tool mount 146, clamp 104 is released from carriage 106. In some aspects, the operator's hand or finger can replace tool 125 to release clamp 104 from carriage 106. This movement of clamp 104 relative to carriage 106 unlocks clamp assembly 102 by moving clamp 104 from the locked position 130 to the unlocked position 132.

To rotate clamp 104 about pivot slots 128 in carriage 106, clamp 104 comprises one or more (e.g., a pair) of projections 150 extending from a body 152 of clamp 104. Projections 150 can be inserted into pivot slots 128, and a void 154 on an upper part of body 152 of clamp 104 facilitates the rotation of a bent clasp 156 against the web 136 of T-bar 112. In various aspects, fabricating projections 150 from stamped portions of sheet metal facilitates manufacturing because the monolithic structure does not need additive manufacturing processes or other parts, such as a hinge or a pivot rod, to facilitate rotation. Similarly, slot 128 can be fabricated by a stamping, cutting, and bending manufacturing process that enhances reliability and minimizes costs associated with additional manufacturing steps. Bent ends 134 (e.g., a pair of feet) on carriage 106 abuts one side of web 136, and bent clasp 156 of clamp 104 abuts an opposite side of web 136 to capture the web 136 and support the clamp assembly 102 in the locked position 130. This way, clamp assembly 102 provides a stable clamping force to support assembly 100.

Saddle 108 can further capture clamp assembly 102 against crossbar 110 and help to distribute the forces generated at clamp assembly 102 to crossbar 110 at joint 158. Saddle 108 comprises a first or front flange 160 with a first front orifice 162 adapted to support crossbar 110 and align with the first aperture 120. A second or rear flange 164 comprises a second rear orifice 166 adapted to support crossbar 110 and align with second aperture 124. A stem 170 is interposed between the front flange 160 and the rear flange 164.

Saddle 108 comprises a pair of opposed flanges, shown as front flange 160 and rear flange 164, each comprising an opening (e.g., orifice 162 and orifice 166) adapted to receive crossbar 110. Flanges 160 and 164 can partially surround one or more components of carriage 106. Saddle 108 can abut and directly support a portion of crossbar 110. A height H1_{S} of saddle 108 is measured between the top end and a bottom end of saddle 108. A depth D1_{S} of saddle 108 can be measured between inner surfaces 168 of the opposing flanges 160 and 164. A depth D1_{S} of saddle 108 can be measured as the distance across stem 170 (or stem portion) joined to either of the opposing flanges 160 and 164. In various aspects, the depth D1_{S} of saddle 108 can be greater than or equal to a depth D2_{C} of carriage 106, e.g., measured between tab 118 and back panel 122, such that saddle 108 can capture tab 118 and back panel 122 of carriage 106.

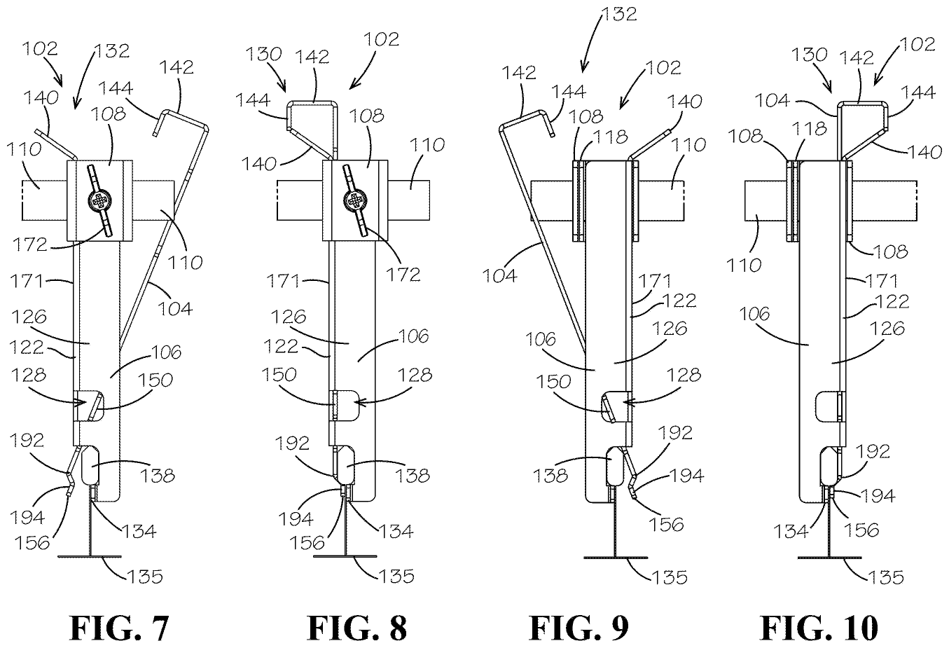

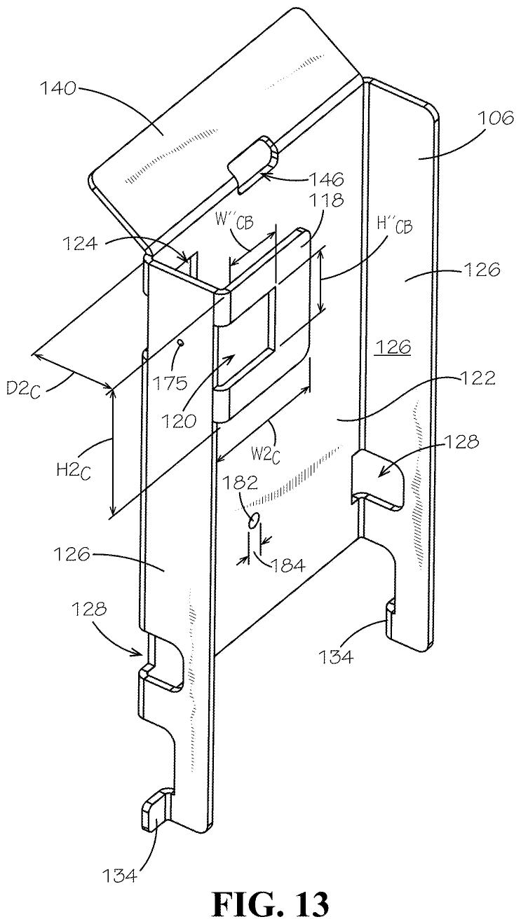

A height H_{CB} and width W_{CB} of crossbar 110 can be the same as or slightly smaller than the height H′_{CB} and width W′_{CB} of front orifice 162 and rear orifice 166 of saddle 108, and/or the height H_{CB}″ and width W_{CB}″ (both shown in FIG. 13) of first aperture 120 and second aperture 124. A height H2_{C} on carriage 106 measures the distance from top to bottom of tab 118, e.g., across void 154 of clamp 104. Height H2_{C} is approximately perpendicular to width W2_{C}, which measures the width W2_{C} of tab 118. The depth D2_{C} of carriage 106 is measured from an outer surface 169 of tab 118 to an outer surface 171 (shown in FIG. 7) of back panel 122. In general, the depth D2_{C} of carriage 106 (measured between the outer surface 169 of tab 118 and the outer surface 171 of back panel 122) is less than or approximately equal to the depth D1_{S} of saddle 108, measured between inner surfaces 168 of front flange 160 and rear flange 164.

In various aspects, a width W3_{V} and a height H3_{V} of void 154 in clamp 104 are greater than the width W2_{C} and/or the height H2_{C} of tab 118 on carriage 106 to facilitate rotating carriage 106 over saddle 108 and/or tab 118. In various aspects, the width W2_{C} and the height H2_{C} of tab 118 are greater (or longer) than a width W1_{S} and the height H1_{S} of front flange 160 and/or rear flange 164 of saddle 108.

Stem 170 of saddle 108 is interposed between front flange 160 and rear flange 164 (e.g., interposed between opposing flanges 160 and 164). Stem 170 can comprise a fastener hole 174 configured to receive a fastener 172. When fastener 172 is tightened in fastener hole 174, the opposing flanges 160 and 164 apply a load in double-shear on crossbar 110. As used herein, double-shear means that the load applied is divided among two structures oriented in approximately two parallel planes to reduce the load carried by either individual structure. Similarly, carriage 106 carries the applied load in double-shear, reducing the load exerted on carriage 106 and significantly reducing the stress reacted in the structures of carriage 106. The length of the stem moment arm (e.g., D1_{S} acting in double-shear (e.g., defined between inner surfaces 168 of opposing flanges 160 and 164 of saddle 108) can be greater than a length of the carriage moment arm (e.g., D2_{C}) defined between tab 118 and back panel 122. In various aspects, the length of the moment arm is proportional to the depths (e.g., D1_{S} and/or D2_{C}). The load applied on saddle 108 is reacted in double-shear and can be less than the load reacted in double-shear by carriage 106. In this way, saddle 108 improves the load distribution of forces on joint 158 between carriage 106 of clamp assembly 102 and crossbar 110. In other words, saddle 108 creates opposed double-shear joints 158 that cooperate to capture crossbar 110 and create a secure, strong joint 158 while minimizing stresses and loads at the joint 158.

In various aspects, fastener 172 can be threadedly engaged with stem 170 of saddle 108 and capture two or more sides of crossbar 110. One end 176 of fastener 172 can engage with carriage 106 and/or crossbar 110. Crossbar 110 can be captured in double-shear against saddle 108, and the load reacted in double-shear through carriage 106. The stem moment arm extends across the stem 170 of the saddle 108 between the pair of flanges, and the carriage moment arm extends across lateral section 126 of carriage 106 (e.g., between the inner surface of tab 118 and the inner surface of back panel 122). The carriage-moment arm can be less than (e.g., shorter than) the stem-moment arm such that a reacted force on tab 118 and back panel 122 of carriage 106 is greater (e.g., higher reacted load) than the reacted force on front flange 160 and rear flange 164 of saddle 108.

Saddle 108 can utilize fastener 172 to tighten the connection between clamp assembly 102 and crossbar 110. For example, saddle 108 can comprise a fastener hole 174, which can be threaded. The threaded fastener hole 174 can be created by stamping and then bending and threading a portion of saddle 108 to receive fastener 172 (e.g., a winged thumb fastener, such as a wing-head thumb screw or bolt). One end 176 of fastener 172 abuts and bears directly against either carriage 106 or crossbar 110. For example, carriage 106 can comprise a threaded fastener hole 175 (shown in FIG. 13), which permits the fastener 172 to engage carriage 106 threadedly and directly abut the crossbar 110. In another aspect, such as the present aspect, fastener 172 can abut against lateral section 126 of carriage 106 directly. The crossbar 110 can be captured between saddle 108, pulling on crossbar 110 in a left-hand direction 178, and carriage 106, which pulls on crossbar 110 in a right-hand direction 180 (e.g., opposite the direction of the saddle 108), as shown in FIG. 1. In other words, when fastener 172 in saddle 108 is tightened, fastener 172 creates a reaction force exerted on crossbar 110. The reaction force can be reacted in double-shear on carriage 106 in one direction and in double-shear by saddle 108 in the opposite direction (e.g., left-hand direction 178 and right-hand direction 180, respectively).

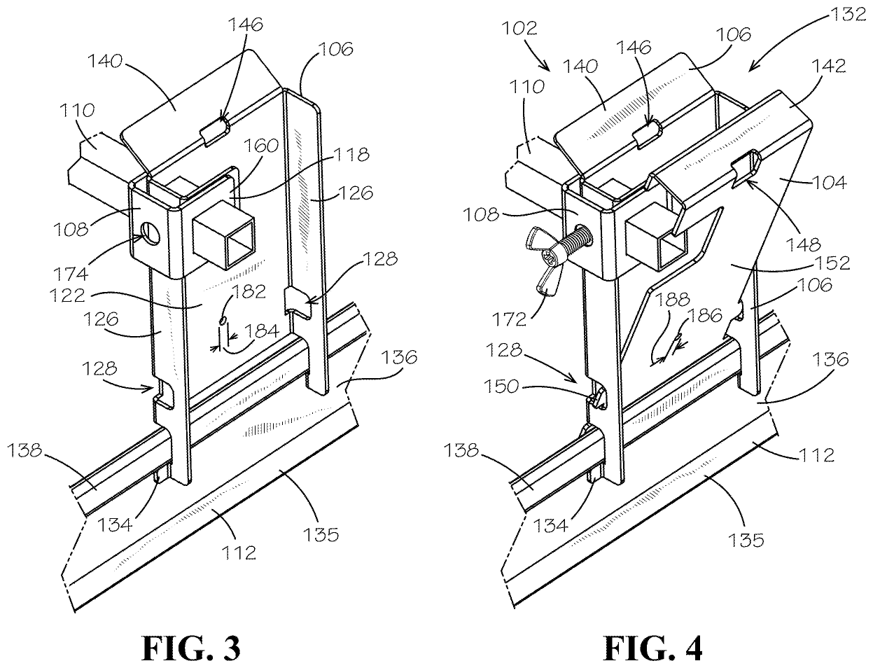

A first fastener passage 182 (FIG. 3) comprising a first diameter 184 extends through back panel 122 of carriage 106, and a second fastener passage 186 (FIG. 4) comprises a second diameter 188 that extends through body 152 of clamp 104. In some aspects, the first diameter 184 of the first fastener passage 182 is adapted to align with the second diameter 188 of the second fastener passage 186. For example, when clamp 104 is locked in the closed, clamped, or locked position 130, the first fastener passage 182 and second fastener passage 186 receive a screw that can lock clamp 104 in the locked position 130 relative to carriage 106. In some aspects, the first diameter 184 of the first fastener passage 182 is aligned with the second diameter 188 of the second fastener passage 186 to receive the screw that couples clamp assembly 102 directly to T-bar 112 or another structure, thus enabling clamp assembly 102 to couple to ceiling frames and other supports in various applications and provide consistent support for the installed support assembly 100.

FIG. 3 illustrates carriage 106 of clamp assembly 102 (shown in FIG. 1) coupled to crossbar 110. FIG. 3 removes clamp 104 and fastener 172 (shown in FIG. 1) to illustrate the interactions of carriage 106 with web 136, a T-bar 112, and saddle 108 on tab 118 and back panel 122 of carriage 106. In some aspects, clamp assembly 102 comes as illustrated in FIG. 4. Projections 150 of clamp 104 can be pre-inserted into pivoting slots 128 of carriage 106, and fastener 172 is pre-installed within saddle 108. This configuration enables the operator to slide clamp assembly 102 over toe 138 of T-bar 112 and insert crossbar 110 into the front and rear orifices 162,166 and apertures 120 and 124 of saddle 108 and carriage 106. When clamp assembly 102 is adequately and appropriately oriented, the operator uses a hand to rotate clamp 104.

FIG. 4 shows clamp 104 in an open or unlocked position 132. As illustrated in FIG. 4, carriage 106 can be bent, and a lower end can form bent ends 134. As described, bent ends 134 each provide a support surface that is or nearly co-planar with web 136 of T-bar 112. Clamp 104 and fastener 172 can be installed on clamp assembly 102 of FIG. 3. Comparing FIGS. 4, 7, and 9, each figure shows clamp assembly 102 installed on crossbar 110, where FIG. 4 illustrates a perspective view and FIGS. 7 and 9 illustrate opposing orthogonal projections of the clamp 104 in the unlocked position 132.

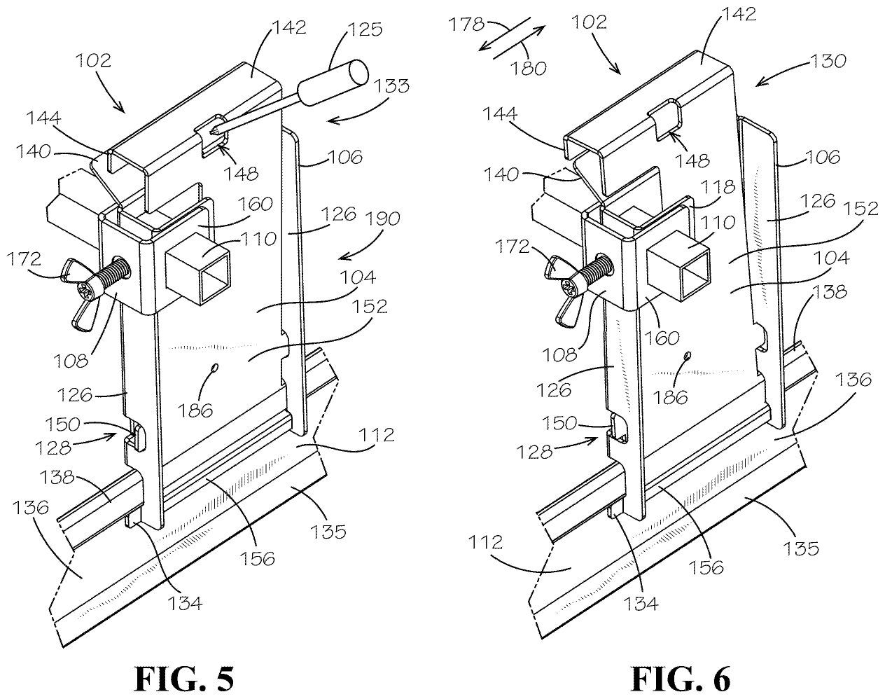

FIG. 5 shows a perspective view of clamp assembly 102 with clamp 104 rotated into a partially closed or closed-unlocked position 133. As illustrated in the closed-unlocked position 133, clamp 104 and carriage 106 are compressing opposite ends of web 136 and capturing toe 138 of T-bar 112. The elevated section 142 and/or lip 144 of clamp 104 comprises not captured elevated ridge 140 of carriage 106 to lock clamp assembly 102 in the locked position 130. Clamp 104 and carriage 106 are closed, but clamp assembly 102 is in a rotated closed-unlocked position 133 because the elevated ridge 140 is not captured by or coupled to the elevated section 142. In addition, the fastener 172 is not tightened to bear against carriage 106 or crossbar 110.

FIG. 6 shows clamp assembly 102 of FIG. 4 with clamp 104 in closed and locked position 130. Lateral section 126 of carriage 106 comprises the threaded fastener hole 175 (FIG. 13) that receives fastener 172 (e.g., a wing-thumb fastener). When fastener 172 is tightened, an end 176 (FIG. 2) of fastener 172 traverses through saddle 108 and carriage 106 and can bear directly on crossbar 110. In some aspects, end 176 of fastener 172 bears directly on lateral section 126 of crossbar 110. Fastener 172 can be tightened to create the opposed double-shear lug configuration of tab 118 and back panel 122 (FIG. 2) of carriage 106 reacting in double-shear against crossbar 110 in a right-hand direction 180 and the opposing flanges 160 and 164 (FIG. 1) of saddle 108 reacting in double-shear against crossbar 110 in the left-hand direction 178, e.g., opposite the carriage 106.

The ceiling panels supported by T-bar 112 can couple to the pair of projections 150 on clamp 104. When clamp 104 is rotated in pivoting slots 128 of carriage 106, the bent clasp 156 and/or bent ends 134 of clamp 104 are compressed against a side or web 136 of T-bar 112. Bent ends 134 and/or bent clasp 156 increase the surface area of the carriage 106 that directly bears against web 136 and helps distribute the reaction forces of the carriage 106 to T-bar 112. Similarly, bent clasp 156 of clamp 104 comprises a large surface area extending across the lower section of body 152 of clamp 104. When bent clasp 156 is compressed against an opposite side of web 136 on T-bar 112, clamp 104 can be rotated into the closed-unlocked position 133. Elevated ridge 140 of carriage 106 can be locked by rotating elevated section 142 of clamp 104 into the locked position 130. In various aspects, lip 144 can overhang elevated ridge 140 to retain ridge 140 in the locked position 130.

With reference to FIGS. 7 through 10, FIGS. 7 and 8 illustrate orthogonal projections of clamp assembly 102 from the left side. Similarly, FIGS. 9 and 10 illustrate the orthogonal projections of clamp assembly 102 from the right side. FIGS. 7 and 9 are left-side and right-side, respectively, orthogonal views of clamp assembly 102 in the unlocked position 132 (e.g., open and unclamped). Similarly, FIGS. 8 and 10 show the left-side and right-side orthogonal views, respectively, of clamp assembly 102 and the locked position 130 (e.g., closed and clamped).

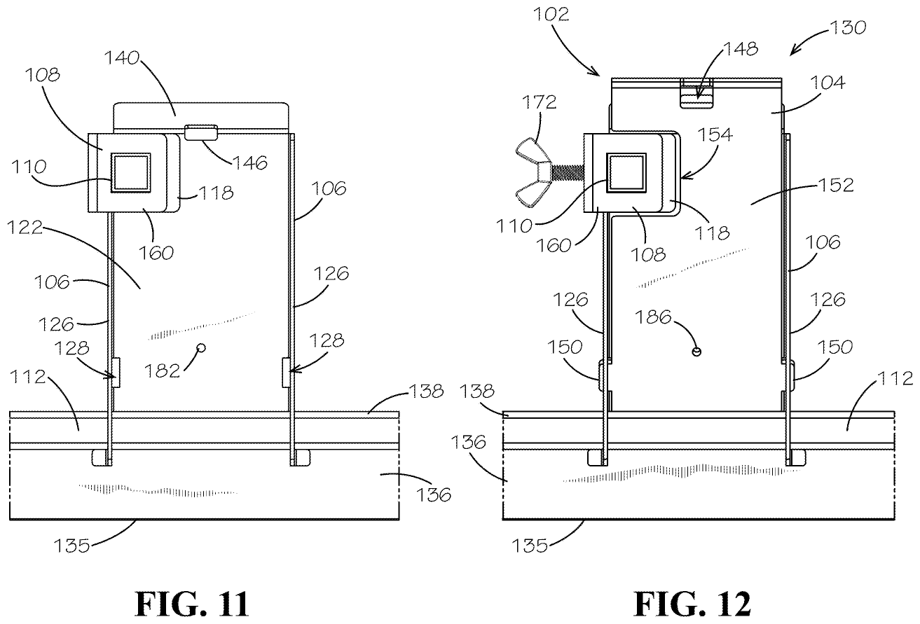

FIG. 11 is a front-side orthogonal view of carriage 106 of clamp assembly 102 (FIG. 1) with clamp 104 removed. FIG. 12 shows a front-side orthogonal view of clamp assembly 102 with carriage 106 and clamp 104, which are oriented in the locked position 130. FIG. 11 shows saddle 108 over crossbar 110 and tab 118 of carriage 106. Tool mount 146 extends through elevated ridge 140 and back panel 122. Back panel 122 further comprises the first fastener passage 182 and a pair of pivoting slots 128 that extend in back panel 122 and lateral sections 126 of carriage 106.

FIG. 12 shows clamp 104 in the locked position 130 within carriage 106. The heights and widths of void 154, flanges 160 and 164 (FIG. 2), and tab 118 illustrate that clamp 104 can freely rotate over saddle 108 and tab 118 of carriage 106 to move from the unlocked position 132 to the locked position 130. That is, the saddle 108, crossbar 110, and/or tab 118 of carriage 106 do not stop clamp 104 from rotation about the pair of projections 150 because the void 154 in clamp 104 is sufficiently large that the saddle 108, crossbar 110, and/or tab 118 of carriage 106 pass through void 154 freely. The rotation moves bent clasp 156 (FIG. 2) under toe 138 and against web 136 of T-bar 112 to clamp or capture the T-bar 112 in the closed position. Lip 144 (FIG. 2) on elevated section 142 (FIG. 2) of clamp 104 can couple to and capture elevated ridge 140 (FIG. 2) of carriage 106 to lock clamp 104 in the locked position 130.

FIG. 13 is an isolated view of carriage 106. Tab 118 and first aperture 120 are oriented substantially parallel relative to back panel 122 and second aperture 124 to support crossbar 110 (FIG. 1) in a double-shear joint 158 (FIG. 1). One or more lateral sections 126 extend along opposing sides of back panel 122 and provide one of the pivoting slots 128, each of which receives the corresponding projection 150 of the clamp 104 and one of the bent ends 134 on each side of back panel 122. Back panel 122 defines the second aperture 124, which cooperates in double-shear with the first aperture 120 of tab 118 to capture and support crossbar 110.

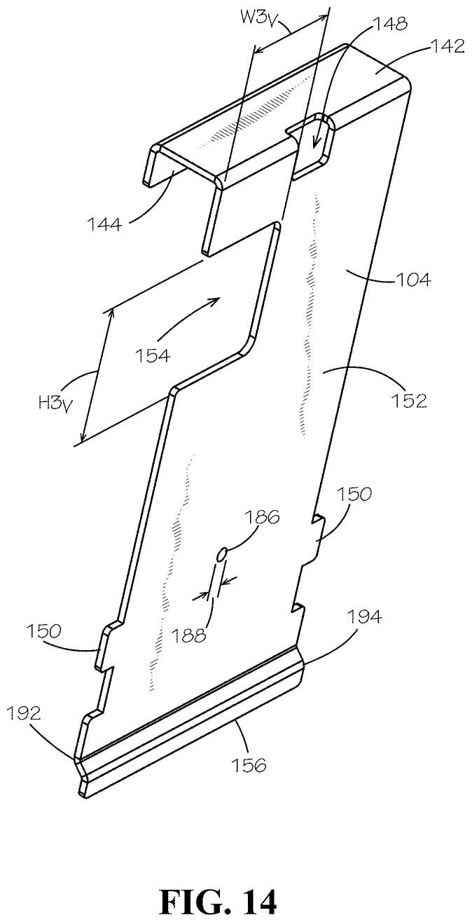

FIG. 14 is an isolated view of clamp 104 showing the opposing pair of projections 150. Void 154 comprises a height (H3_{V}) and a width (W3_{V}) sufficient to rotate clamp 104 over tab 118 of carriage 106 and saddle 108 of the clamp assembly 102 (all shown in FIG. 2). A bottom portion of body 152 on clamp 104 comprises a pair of bend lines (e.g., first bend 190 and second bend 192) that form bent clasp 156. The first bend 190 captures a portion of toe 138 (FIG. 2), and the second bend 192 facilitates the abutment of bent clasp 156 against web 136 of T-bar 112 (FIG. 2). Using the first bend 190 and second bend 192 on bent clasp 156 facilitates capturing T-bar 112 on two or more surfaces, e.g., toe 138 and web 136 of T-bar 112.

In some aspects, the support assembly installation method comprises engaging a carriage 106 with a T-bar 112. Carriage 112 comprises a pivot slot 128 and a clamp 104 is rotated about the pivot slot 128 from an unlocked position 132 to a locked position 130 to couple the clamp 104 and the carriage 112 and to capture a portion of the T-bar 112 (e.g., bottom flange 135, web 136, and/or toe 138). Clamp 104 can comprises one or more projections 150 extending through the pivot slot 128.

In various aspects, the method can further include sliding a crossbar 110 through an opening (e.g., orifice 162 and/or orifice 166) of saddle 108. The crossbar 110 can slide through an opening (e.g., apertures 120 and/or 124) of carriage 106. Clamp 104 can be rotated and/or pivoted into the locked position 130 by capturing an elevated ridge 140 of the carriage 106 abutting a lip 144 of clamp 104. A tool 125 can be inserted into a through-hole 148 in lip 144 of clamp 104. The tool 125 can rest on tool mount 146 in the elevated ridge 140 of carriage 106 until tool 125 is rotated to move the lip 144 of clamp 104 away from the elevated ridge 140 of carriage 106.

In some aspects, clamp 104 and/or carriage 106 can be manufactured from a stamped and/or cut sheet metal and then bent into a three-dimensional shape to form clamp 104 and/or carriage 106.

The method of claim 26, further comprising:
engaging a saddle with a crossbar being supported by the carriage, the saddle comprising a stem interposed between a first flange defining a first orifice and a second flange defining a second orifice; and
engaging the crossbar with an aperture of the carriage, wherein the crossbar is received and extends through the first orifice, the second orifice, and the aperture.

The description is provided as an enabling teaching of the present devices, systems, and/or methods in their best, currently known aspect. To this end, those skilled in the relevant art will recognize and appreciate that many changes can be made to the various aspects described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context dictates otherwise. Thus, for example, reference to a quantity of one of a particular element can comprise two or more such elements unless the context indicates otherwise. In addition, any elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials and processes and between different models, the tolerance for a particular measurement of a particular component can fall within a range of tolerances.

As used herein, the terms “optional” or “optionally” mean that the subsequently described event or circumstance may or may not occur and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B,”; while the phrase “one of A and B” means “A or B.”

Unless the context dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal to the front; “left” is that which is to the left of or facing left from a person sitting in the seat and facing towards the front, and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless expressly stated otherwise, or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code that comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

That which is claimed is:

1. A clamp assembly comprising:
a carriage comprising:
a back panel defining an aperture; and
a lateral section extending from the back panel, the lateral section comprising a pivoting slot; and
a clamp comprising a projection extending through the pivoting slot of the carriage.

2. The clamp assembly of claim 1, wherein:
the aperture in the back panel of the carriage is a first aperture;
the carriage comprises a tab defining a second aperture, the first aperture and the second aperture adapted to support a crossbar.

3. The clamp assembly of claim 1, further comprising a saddle comprising:
a first flange comprising a first orifice adapted to support a crossbar and align with the aperture;
a second flange comprising a second orifice adapted to support the crossbar and align with a second aperture; and
a stem interposed between the first flange and the second flange.

4. The clamp assembly of claim 1, further defining a first fastener passage extending through the carriage and a second fastener passage extending through the clamp, wherein a diameter of the first fastener passage is adapted to be aligned with a diameter of the second fastener passage when the clamp is locked in a locked position.

5. The clamp assembly of claim 1, wherein the carriage and the clamp each comprise a stamped and bent metal sheet.

6. The clamp assembly of claim 1, wherein the pivoting slot of the carriage are configured to rotate the projection of the clamp between an unlocked position and a locked position.

7. The clamp assembly of claim 1, further comprising a saddle, wherein:
the clamp defines a void;
the carriage defines a tab;
a width and a height of the void is greater than a width and a height of the tab; and
the width and the height of the tab are greater than a width and a height of a flange of the saddle.

8. The clamp assembly of claim 1, further comprising a T-bar of a ceiling panel, wherein the projection of the clamp is configured to rotate in the pivoting slot of the carriage from an unlocked position to a locked position, wherein in the locked position a bent end of the carriage is compressed against a side of the T-bar, and a bent clasp is compressed against an opposite side of the T-bar when the clamp is rotated into the locked position.

9. The clamp assembly of claim 1, wherein the carriage further comprises an elevated ridge, and the clamp further comprises an elevated section configured to capture the elevated ridge in a locked position.

10. The clamp assembly of claim 1, wherein:
the carriage comprises an elevated ridge extending at an acute angle from the back panel of the carriage;
the clamp comprises an elevated section and a lip; and
in a locked position, the lip of the clamp abuts the elevated ridge of the carriage to capture the carriage within the elevated section of the clamp.

11. The clamp assembly of claim 10, wherein:
the carriage further comprises a tool mount; and
the clamp further comprises a through-hole.

12. The clamp assembly of claim 1, further comprising a saddle comprising a threaded fastener hole and a thumb fastener received within the threaded fastener hole.

13. The clamp assembly of claim 12, wherein the carriage further comprises a second threaded fastener hole that receives the thumb fastener, such that when tightened, an end of the thumb fastener traverses through the threaded fastener hole of the saddle and the second fastener hole of the carriage.

14. The clamp assembly of claim 1, wherein the carriage comprises a first lateral section opposed from a second lateral section, a first pivoting slot in a lower portion of the first lateral section opposes a second pivoting slot in a lower portion of the second lateral section.

15. The clamp assembly of claim 14, wherein the projection on the clamp is a first projection, the clamp further comprises a second projection, the first projection extending through the first pivoting slot of the first lateral section of the carriage, and the second projection extending through the second pivoting slot of the second lateral section of the carriage.

16. The clamp assembly of claim 14, wherein the first pivoting slot is located at a height below a midline defined halfway between a top of the back panel and a bottom of a bent end of the first lateral section, the second pivoting slot being located at an equal height on the second lateral section, and wherein the height is above a bottom of the back panel.

17. A saddle for a support assembly comprising:
a pair of flanges, each comprising an opening adapted to receive a crossbar and configured to partially surround components of a carriage supporting the crossbar, such that a depth measured between inner surfaces of the flanges is greater than a depth of the carriage; and
a stem portion interposed between the flanges and comprising a fastener hole; wherein:
when a fastener is tightened in the fastener hole, the flanges apply a load in double-shear, and the carriage applies the load in double-shear; and
a length of a moment arm of the stem portion is proportional to the depth measured between the inner surfaces of the flanges and is greater than a length of a moment arm of the carriage proportional to the depth of the carriage.

18. The saddle of claim 17, wherein a load of the saddle in double-shear is less than the load reacted by the carriage in double-shear.

19. The saddle of claim 17, wherein the fastener is threadedly engaged with the stem portion of the saddle to capture the crossbar, and an end of the fastener is engaged with the carriage, wherein:
the crossbar is captured in double-shear against the saddle and comprises a first-moment arm that extends over the stem portion between the pair of flanges of the saddle; and
the crossbar is captured in double-shear against the carriage, and the carriage comprises a second-moment arm that is less than the first-moment arm.

20. A support assembly comprising:
a hub slidably coupled to a crossbar, the hub adjustably supporting a sprinkler; and
a clamp assembly on the crossbar, the clamp assembly coupled to a T-bar and comprising:
a carriage comprising:
a tab defining a first aperture adapted to support the crossbar;
a back panel defining a second aperture adapted to support the crossbar;
a lateral section extending between the tab and the back panel, the lateral section comprising a pivoting slot;
a clamp comprising a projection extending through the pivoting slot of the carriage; and
a saddle comprising:
a first flange comprising a first orifice adapted to support the crossbar and align with the first aperture;
a second flange comprising a second orifice adapted to support the crossbar and align with the second aperture; and
a stem interposed between the first flange and the second flange.

21. The support assembly of claim 20, wherein an end of a fastener is configured to bear directly against the crossbar.

22. The support assembly of claim 20, wherein the clamp assembly is a first clamp assembly and further comprising a second clamp assembly, wherein the first and second clamp assemblies are the same size and shape when oriented in a locked position relative to the crossbar; when the carriage, the clamp, and the saddle, of each of the first and second clamp assemblies are clamped to opposing T-bars and support the crossbar.

23. The support assembly of claim 20, further comprising a first fastener passage in the carriage and a second fastener passage in the clamp, wherein a screw in the first and second fastener passages locks the clamp in a locked position relative to the carriage.

24. The support assembly of claim 20, further comprising a fastener coupled to each saddle, wherein, when the fastener is tightened, it exerts a reaction force in the crossbar, and wherein the reaction force is reacted in double-shear by the carriage in one direction and in double-shear by the saddle in an opposite direction.

25. The support assembly of claim 24, wherein:
a first-moment arm extends across the stem of the saddle between the first flange and the second flange; and
a second-moment arm extends across the lateral section of the carriage between the tab and the back panel, the second-moment arm being less than the first-moment arm such that a force reacted by the carriage is greater than the force reacted by the saddle.

26. A method for installing a support assembly comprising:
engaging a carriage with a T-bar, the carriage comprising a pivot slot; and
rotating a clamp about the pivot slot from an unlocked position to a locked position to couple the clamp and the carriage to the T-bar, the clamp comprising projections extending through the pivot slot.

27. The method of claim 26, wherein rotating the clamp into the locked position further comprises capturing an elevated ridge of the carriage abutting a lip of the clamp.

28. The method of claim 26, further comprising:
inserting a tool into a through-hole in a lip of the clamp;
resting the tool on a tool mount in an elevated ridge of the carriage;
rotating the tool; and
moving the lip of the clamp away from the elevated ridge of the carriage.

29. The method of claim 26, further comprising forming the clamp and the carriage by stamping and bending sheet metal into three-dimensional shapes.

30. The method of claim 26, further comprising:
engaging a saddle with a crossbar being supported by the carriage, the saddle comprising a stem interposed between a first flange defining a first orifice and a second flange defining a second orifice; and
engaging the crossbar with an aperture of the carriage, wherein the crossbar is received and extends through the first orifice, the second orifice, and the aperture.
